(19) United States
(12) Patent Application Publication
(10) Pub. No.: US 2020/0227838 A1
(43) Pub. Date: Jul. 16, 2020

(54) CONNECTED ASSEMBLY

(71) Applicants: Tyco Electronics (Shanghai) Co., Ltd., Shanghai (CN); Tyco Electronics Technology (SIP) Co.,Ltd., Jiangsu Province (CN)

(72) Inventors: Chao YAN, Suzhou Jiangsu (CN); Xiaodong PENG, Suzhou Jiangsu (CN); Ziwei LI, Shanghai (CN); Litao DONG, Shanghai (CN); Bingjing XUE, Shanghai (CN)

(21) Appl. No.: 16/737,995

(22) Filed: Jan. 9, 2020

(30) Foreign Application Priority Data
Jan. 11, 2019 (CN) 201920050849.8

(51) Int. Cl. H01R 4/02; H01R 4/58; H01M 2/20

(52) U.S. Cl. CPC H01R 4/029; H01R 43/0221; H01M 2/20; H01R 4/58

(57) ABSTRACT

The present application provides a connected assembly having a first component and a second component. A coating is provided on an upper surface of the first component, wherein the coating has a lower reflectivity than that of the upper surface of the first component; and the second component and the first component are separately molded and connected by welding. The solution provided by the present application improves welding quality between the components of copper materials with a lower cost.

### TECHNICAL FILED

The present application relates to a connected assembly, and more particularly to a connected assembly for use in laser welding.

### BACKGROUND

Laser welding technology is a technology which uses laser beam as an energy source to impact a workpiece to achieve the purpose of welding. The laser welding can reduce deformation caused by heat conduction in the welding process and lessen wear-out of tools. The laser beam can be focused on a very small area, and can weld small and closely spaced parts. Because the laser welding has many advantages, it is widely used in various fields. For example, it is applied for welding electrically conductive materials inside a battery in the field of battery manufacture. Copper is a common conductive material in batteries. When a copper material is welded by laser, the welding spot tends to be too deep or too shallow, resulting in unstable welding quality. The present application will solve the problems.

### SUMMARY OF THE INVENTION

According to an aspect of the present application, there is provided a connected assembly comprising: a first component, an upper surface of the first component being provided with a coating, the coating having a lower reflectivity than that of the upper surface of the first component; and a second component, wherein the second component and the first component are molded separately and connected together by welding.

According to an embodiment of the connected assembly, the coating is applied by an inkjet process.

According to an embodiment of the connected assembly, the coating is applied by a coating process.

According to an embodiment of the connected assembly, the coating is applied by a printing process.

According to an embodiment of the connected assembly, the coating is made of an optically absorptive material.

According to an embodiment of the connected assembly, the first component is made of a copper material.

According to an embodiment of the connected assembly, the second component is made of a copper material.

According to an embodiment of the connected assembly, the connected assembly is configured for connecting electrically conductive materials inside a battery.

According to an embodiment of the connected assembly, the first component is a copper core of a flat cable.

According to an embodiment of the connected assembly, one or more welding connection spots are formed between the first component and the second component.

According to an embodiment of the connected assembly, welding connection traces between the first component and the second component are linear.

According to an embodiment of the connected assembly, the first component and the coating together form a coated first component, and the coated first component has a reflectivity to laser no more than 85%.

According to an embodiment of the connected assembly, the first component and the coating together form a coated first component, and the coated first component has a reflectivity to laser no more than 83%.

According to an embodiment of the connected assembly, the coating is made of ink.

According to an embodiment of the connected assembly, the coating has a uniform thickness before the first component is welded and connected to the second component.

According to an embodiment of the connected assembly, the coating is applied to continuously extend on the upper surface of the first component before the first component is welded and connected to the second component.

According to an embodiment of the connected assembly, the coating is completely adhered to the upper surface of the first component before the first component is welded and connected to the second component.

According to an embodiment of the connected assembly, at least part of the coating is discontinuously provided on the upper surface of the first component after the first component is welded and connected the second component.

The solution provided by the application improves welding quality between the components made of copper materials with a lower cost.

### BRIEF DESCRIPTION OF DRAWINGS

FIG. 1 is a bottom view of a coated first component of the present application;

FIG. 2 is a top view of the coated first component of the present application;

FIG. 3 is a side view of the coated first component in FIG. 2;

FIG. 4 is a top view of a second component of the present application;

FIG. 5 is a side view of the coated first component and the second component of the present application; and

FIG. 6 is a flow chart of a welding method of the present application.

### DETAILED DESCRIPTION OF EMBODIMENTS

Various specific embodiments of the present application will now be described with reference to the accompanying drawings, which form part of the specification. It is to be understood that while directional terms, such as “front”, “rear”, “upper”, “lower”, “left”, “right”, and the like, are used herein to describe various example structural parts and elements of the present application, these terms used herein are only intended for the purpose of convenient explanation and determined based on example orientations shown in the figures. Since the embodiments disclosed herein may be provided in different orientations, these directional terms should be considered merely as illustration rather than limitation.

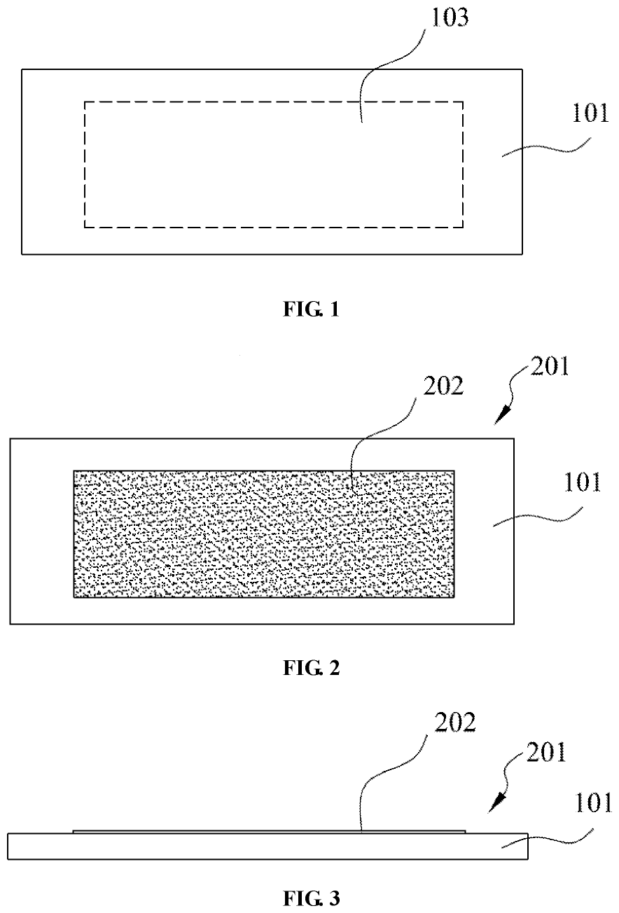

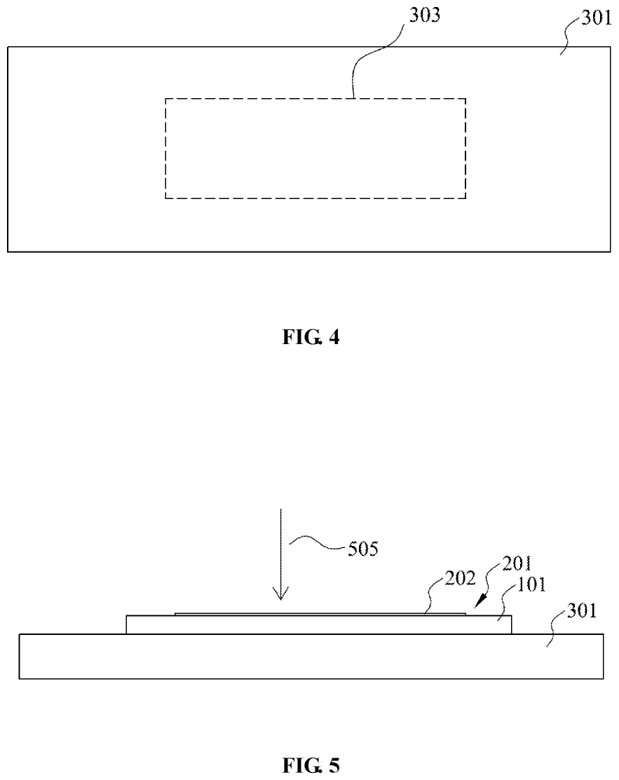

FIG. 1 is a bottom view of a coated first component of the present application showing a lower surface of the first component 101. The first component 101 has a first welding area 103, and the first component 101 is welded to a second component by exposing a range defined by the first welding area 103 of the first component 101 to a laser beam. The lower surface of the first component 101 has the same material as that of the main body of the first component 101.

FIG. 2 is a top view of the coated first component of the present application; FIG. 3 is a side view of the coated first component in FIG. 2; as shown in FIGS. 2 and 3, a coating 202 is provided on an upper surface of the first component 101 to form a coated first component 201. The coated first component 201, as a component to be welded, is configured to be welded to the second component. The coating 202 is located over the first component 101, with the area of the coating 202 being substantially equal to the area of the first welding area 103; i.e., the coating 202 can be aligned with the first welding area, so that a contact point between the laser and the coated first component 201 will fall within the range defined by the coating 202. The coating 202 is made of an optically absorptive material, and has a lower reflectivity to laser than that of the upper surface of the first component 101. When being irradiated on the coating 202, the laser is partially absorbed by the coating 202, with the reduced reflectivity of the surface of the coated first component 201 to the laser, and thus the utilization rate of the laser is increased, so that the welding quality can be improved. In an embodiment of the present application, the coating 202 is rectangular. In other embodiments, the coating 202 may be any shape, provided that it can cover the to-be-welded area of the first component 101 so that a contact point between the laser and the coated first component 201 is within the range of the coating 202. The coating 202 has a uniform thickness and is completely adhered onto the first component 101 so that the coating 202 will not easily fall off the first component 101 prior to welding. That is, the coating 202 will always be attached to the first component 101 while an operator is routinely moving and flipping the coated first component 201. The coating 202 is disposed to continuously extend on the upper surface of the first component 101; i.e., the coating 202 is uniformly distributed on the upper surface of the first component 101 and can cover the first welding area 103. The reflectivity of the coated first component 201 to the laser is required to be no more than 85%, and more preferably, no more than 83%. As used herein, the reflectivity refers to a reflectivity of a coating-containing area of the coated first component 201 to the laser. In an embodiment, the coating 202 is made of black or dark colored ink. In an embodiment, the coating 202 is applied by ink jetting from an inkjet printer that densely sprays ink dots onto the upper surface of the first component 101 to build up a coating. In another embodiment, the coating 202 is applied by a coating process, during which an operator or automated equipment uses a coating tool to dip and coat ink onto the surface of the first component 101 to form the coating 202. In yet another embodiment, the coating 202 is applied by a printing process, during which black ink is printed onto the upper surface of the first component 101 by a printing device.

FIG. 5 is a side view of the coated first component and the second component of the present application. As shown in FIG. 5, the first component 101 and the second component 301 together constitute a connected assembly, and the first component 101 and the second component 301 are separately and independently molded. When it is desired to weld the coated first component 201 to the second component 301, the coated first component 201 is overlaid onto the second component 301. That is, the first welding area 103 of the first component 101 is aligned with the second welding area 303 of the second component, and the lower surface of the first component 101 is in contact with the upper surface of the second component 301. The laser beam is irradiated downwards from above the coated first component 201 in a direction indicated by an arrow 505, so that the laser beam is in contact with the coating 202 and partially absorbed. The first component 101 and the second component 301 are melted by absorbing energy in the direction of the laser beam, so that a connection is formed between the upper surface of the first component 101 and the lower surface of the second component 301, and the first component 101 is welded to the second component 301. The welding operation may be single welding to form one welded connection spot, or multiple welding to form a plurality of welded connection spots. After single welding is completed, the position of the laser beam is moved, and the laser welding operation is repeated, so that a plurality of welded connection spots are formed between the first component 101 and the second component 301. All the welding connection spots are positioned within the range defined by both the first welding area 103 and the second welding area 303. The welding operation may be continuous welding; i.e., the laser beam is moved at such a speed that the welded connection traces between the first component 101 and the second component 301 are linear. After the welding is completed, a part of the coating 202 falls off or disappears from the upper surface of the first component 101, and another part thereof remains on the upper surface of the first component 101. That is, the part of the coating 202 near the irradiation of the laser beam is affected by the laser energy and thus after welding falls off or disappears from the upper surface of the first component 101, while the part of the coating 202 away from the irradiation of the laser beam still remains on the upper surface of the first component 101 after welding.

Table 1 below shows test data for the laser welding of coated components of the present application and laser welding between bare copper components.

TABLE 1

| Test item | Bare copper | Coating-containing |
|---|---|---|
| Average pull strength | 73.3N | 75.5N |
| CPK | 2.04 | 5.04 |

As shown in the above table, the component is coated and then welded in the present application. Compared with directly welding between bare copper, the pull strength between the components welded after the coating treatment of the component is higher, that is, the weld is stronger. Moreover, the CPK index of the components welded after the component is coated is higher, namely, higher process capability, so that products with high quality and reliability can be stably produced. Compared with directly welding the bare copper components, the laser welding method in the present application has significant advantages.

In an embodiment of the present application, the first component 101 is a copper core in a flexible flat cable, and the second component 301 is a bus bar. The flexible flat cables are used in batteries to connect electrically conductive components, and the copper cores in the flexible flat cables need to be welded to the bus bars to enable the flexible flat cables to be in electrical communication with the bus bars. The copper core is a copper sheet with a smaller area and thinner thickness, and the laser welding process can be adapted to smaller components. When a laser welding process is used for welding between components made of copper materials, the quality of welding is easily affected, e.g., the welding spot being too deep or too shallow, because the surface of bare copper has higher reflectivity to the laser. To solve this problem, one of the solutions is to add a plating, such as nickel plating, to the surface of the component of copper material, thereby improving the welding quality. However, the plating process on the surface of the component of the copper material is complex and higher in cost. In the present application, the problems associated with laser welding are ameliorated by adding a coating onto the surface of the first component 101, with simple process and lower cost, to thereby satisfy requirements of practical application.

In this embodiment, both the first component 101 and the second component 301 are made of bare copper, and after completion of welding, the material at the connection spot between the first component 101 and the second component 301 is the same as that of the first component 101 and the second component 301, without any other material introduced. That is, the electric conduction between the first component 101 and the second component 301 is achieved by the copper material, with better electrically conductive performance. However, in the solution for improving the welding by adding the plating onto the first component 101, the plating of the first component 101 comes into contact with the second component 102, so that after completion of the welding, the material containing the plating at the connection between the first component 101 and the second component 301 may have an influence on the electrical conductivity and welding stability between the first component 101 and the second component 301.

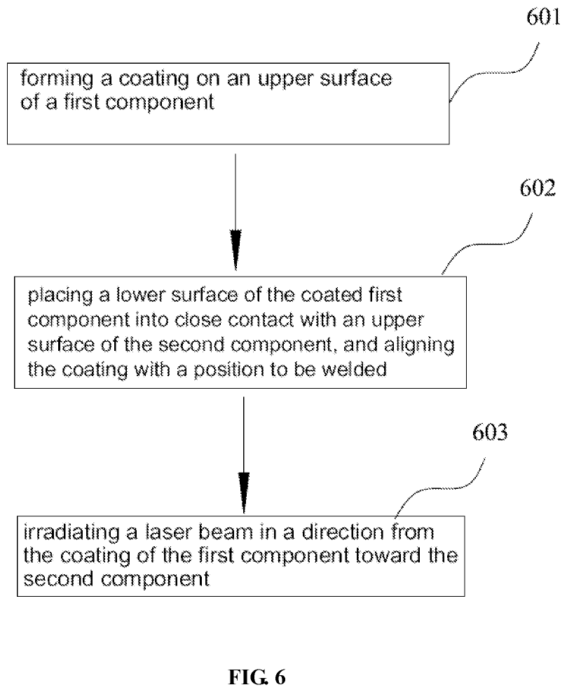

FIG. 6 is a flow chart of the welding method of the present application. The welding method comprises the following steps:

step 601, forming a coating 202 on an upper surface of a first component 101 to thereby form a coated first component 201;

step 602, placing a lower surface of the first component 201 with the coating 202 into close contact with an upper surface of the second component 301, and aligning the coating 202 with a position to be welded; and

step 603, irradiating a laser beam in a direction from the coating 202 of the first component 101 toward the second component 301, to thereby weld the first component 101 and the second component 301 together.

In the step 603, the laser beam may be irradiated once, or multiple times at different positions, so that one or more welding joints can be formed between the first component 301 and the second component 301, or may be moved at such a speed that continuous linear welding connection traces can be formed between the first component 101 and the second component 301.

Although only some features of the present disclosure have been illustrated and described herein, many modifications and variations can be made by those skilled in the art. It is, therefore, to be understood that the appended claims are intended to cover all such modifications and variations falling within the substantive spirit of the present disclosure.

1. A connected assembly, comprising:
a first component, an upper surface of the first component being provided with a coating, the coating having a lower reflectivity than that of the upper surface of the first component; and
a second component, wherein the second component and the first component are molded separately and connected by welding.

2. The connected assembly of claim 1, wherein the coating is applied by an inkjet process.

3. The connected assembly of claim 1, wherein the coating is applied by a coating process.

4. The connected assembly of claim 1, wherein the coating is applied by a printing process.

5. The connected assembly of claim 1, wherein the coating is made of an optically absorptive material.

6. The connected assembly of claim 1, wherein the first component is made of a copper material.

7. The connected assembly of claim 1, wherein the second component is made of a copper material.

8. The connected assembly of claim 1, wherein the connected assembly is configured for connecting electrically conductive materials inside a battery.

9. The connected assembly of claim 1, wherein the first component is a copper core of a flat cable.

10. The connected assembly of claim 1, wherein one or more welding connection spots are formed between the first component and the second component.

11. The connected assembly of claim 1, wherein welding connection traces between the first component and the second component are linear.

12. The connected assembly of claim 1, wherein the first component and the coating together form a coated first component, and the coated first component has a reflectivity to laser no more than 85%.

13. The connected assembly of claim 1, wherein the first component and the coating together form a coated first component, and the coated first component has a reflectivity to laser no more than 83%.

14. The connected assembly of claim 1, wherein the coating is made of ink.

15. The connected assembly of claim 1, wherein the coating has a uniform thickness before the first component is welded and connected to the second component.

16. The connected assembly of claim 1, wherein the coating is applied to continuously extend on the upper surface of the first component before the first component is welded and connected to the second component.

17. The connected assembly of claim 1, wherein the coating is completely adhered to the upper surface of the first component before the first component is welded and connected to the second component.

18. The connected assembly of claim 1, wherein at least part of the coating is discontinuously provided on the upper surface of the first component after the first component is welded and connected to the second component.
